(19) United States
(12) Patent Application Publication
(10) Pub. No.: US 2015/0075679 A1
(43) Pub. Date: Mar. 19, 2015

(54) Induction Heat-Treating Apparatus and Process

(71) Applicant: METALSA S.A. DE C.V., Monterrey (MX)

(72) Inventor: Rene Javier Hinojosa Garza, Apodaca (MX)

(21) Appl. No.: 14/468,966

(22) Filed: Aug. 26, 2014

Related U.S. Application Data
(60) Provisional application No. 61/870,738, filed on Aug. 27, 2013.

(51) Int. Cl. C21D 1/42; H05B 6/44; C22F 1/00; C21D 11/00; C21D 1/667

(52) U.S. Cl. CPC C21D 1/42; C21D 11/00; C21D 1/667; C22F 1/002; C22F 1/00; H05B 6/44
USPC 148/574; 266/129; 219/653

(57) ABSTRACT

An apparatus for induction heat treating and quenching a metallic part with rolls to convey, guide and restrain the part during processing. The apparatus includes a heating coil assembly with two sections of coils wound in opposite directions. The apparatus may include a quenching station with individual quenching sections having different pressures and flows of a liquid. A process for induction heat treating and quenching a metallic part in a series of rolls includes induction heating the part in a counter-wound coil assembly; quenching the part with a liquid while under restraint, and induction heating the part again after quenching. Controlling varying speed and the proximity of the metallic part to the coil assembly is ideal.

### CROSS REFERENCE TO RELATED APPLICATION

This application asserts priority from provisional application 61/870,738, filed on Aug. 27, 2013, which is incorporated herein by reference.

### FIELD OF THE DISCLOSURE

This disclosure relates to an induction heat-treating apparatus and a related process.

More specifically, the disclosure relates to heat treating a part, such as a side rail, with controlled speed of the part and the part proximity to heating coil assembly with coils that are preferably counter-wound.

### BACKGROUND

Apparatus have been devised for heat treating structural members, such as vehicle side rails. Parts, such as side rails, are presently heat treated in relatively large furnaces with a high volume capacity. The investment and scale of such furnaces are both large.

U.S. Pat. No. 4,394,194 discloses a method and apparatus for induction heat treating and restraint quenching structural members of carbon steel, to a uniform martensitic structure, such that distortion of the member due to rapid quenching is controlled to a minimum. More specifically, the member is generally heated by induction in two stages generally to an austenitizing temperature in the range of 1450 degrees to 1750 degrees F. Then the member is liquid quenched under restraint to below 1000 degrees F. to minimize distortion and finally tempered under restraint at a temperature in the range of 750 degrees to 1250 degrees F. Such structural members attain minimum physical properties after heat treating in the range of 110,000 psi yield strength and 125,000 psi tensile strength.

Prior art FIG. 1 is sourced from the “194 patent and as disclosed therein, FIG. 1 shows a heat treat line for the treatment of carbon steel channel-shaped structural members 20. An entry table 22 stacks and presents the structural members 20 in a sequential and singular fashion to the conveyor rolls 24 found at the lower edge of entry table 22. As the structural members 20 are fed from the entry table 22 onto the conveyor rolls 24, the conveyor rolls 24 will convey the structural members 20 to the point of entry into the vertical side guide and restraint rolls 26 and 54.

The combination of the vertical side guide and restraint rolls 26 and 54 and the last succeeding or first leaving conveyor rolls 24 are used on each end of the heat treat line so as to formulate a combination system of rolls. The configuration of the vertical side guide and restraint rolls 26 is particularly suited to the containment of the structural member 20 in both horizontal and vertical alignment for entry and leaving from the heat treat line as seen in FIG. 1.

It can also be noted from FIG. 1 that the direction of travel is indicated by the directional arrows seen from the entry table onto the line and in line from left to right as shown in FIG. 1 to the exit point onto the cooling table 23.

At such time as the structural member 20 enters the vertical side guide and restraint rolls 26, the structural member 20 then commences its entry into the first of the heating stations which contains a preheating coil 28. As the structural member 20 exits the preheat coil 28, it encounters a first set of pinch rolls 30. It is this set of pinch rolls 30 that drives the structural member 20 to the next set of heat induction coils 32 while maintaining vertical restraint on structural member 20. Between the two heat induction coils 32 there is a supporting roll assembly 34 which supports the structural member 20 in correct vertical alignment for entry into the second set of heat induction coils 32.

As the structural member 20 exits the second set of heat induction coils 32, it enters a second set of pinch-restraint rolls 36. The pinch-restraint rolls 36 drive the structural member 20 into the quench zone 40. In this quench zone 40, the structural member 20 is surrounded on all sides by the multiplicity of liquid supplies 44 which through a series of apertures will supply an ample amount of liquid to quickly reduce the temperature of the structural member. Additionally at the exit end of the quench zone 40, sets of guide rolls 48 assures that the member 20 progresses evenly and steadily to the pinch rolls 30 which next drive the structural member 20 to the next set of pinch rolls 30 to prepare the material for the next stage of processing.

Next follows the tempering section with an induction coil 50 in which the temperature of the structural member 20 is again raised. Immediately following the tempering section with induction coil 50 is another set of drive pinch rolls 36. Following the drive pinch rolls 36 are further sets of vertical restraint rolls 54 and 26 restraining the flange members of the structural member 20 so as to assure the true configuration of the structural member 20 through the final stage of processing. The final set of rolls utilized in the processing stage are the exact mirror image of the very first set of rolls used in the processing stage. Finally, the structural member is conveyed to the ends of the conveyor rolls 24 and then moved laterally onto the cooling tables 23.

Each of the induction heating coils 28, 32 and 50 are fitted with an alternating current through a generation system which will produce varying frequencies. These heat stations 56 are individualized so as to feed each one of the heating induction coils 28, 32 and 50 with the required power of alternating current to produce the most energy efficient means of heating the structural member 20 to the desired temperature ranges.

That method and apparatus for induction heat treating are specifically disclosed for use with a truck side rail as the heat-treated part.

Adaptions are needed from the current methods and apparatus to make them work better, including more practical frequencies and temperatures with a properly scaled project. A higher efficiency apparatus and method are desirable with better control and less distortion of the heat-treated part.

### SUMMARY

The present disclosure provides induction heat-treating apparatus and process for heat-treating parts. This system is well suited for side rails of a vehicle as the heat-treated part.

The induction heat-treating apparatus and processes include improvements over the apparatus and method disclosed in U.S. Pat. No. 4,394,194. No preheating is required with the presently disclosed induction heat-treating apparatus and process. The relationship between speed in which a part passes through the process and the heating coil size assists with avoiding a preheating requirement. Previously preheating at different temperatures required two frequencies and power sources.

The present counter-wound design with a space separating the heating coils allows the temperature to be leveled. The coils can use the same frequency and power source with the present design.

A relatively slow speed of less than 100 inches per minute avoids a large hot area on a treated part and the resulting problematic distortion of such part. Varying the exit speed of the part from the process and the entrance speed of the part into the process can be a factor for this apparatus and process. While the speed of advance of a part through the heat treat system is known to influence operating conditions, the change in speed via acceleration or deceleration at entry, through specific sections and at exit can now be controlled via computer for enhanced performance and characteristics of the part.

Also, a defined distance between the part and the heating coil assembly (part proximity) affects the heat-treating performance. The part proximity can be set to maximize the heat treating benefits for the part. While sometimes set at a predetermined distance, the part proximity be controlled for enhanced performance and characteristics of the part.

Next, two coil sections of the heating coil assembly preferably wind in opposite directions. The induction on some heating coils is done from one distal end of the coil section to the other extreme, and a second coil section is wound the other way around. The opposing winding helps avoid the part being pushed by the “electricity force” or in other words, the electromagnetic forces generated by the induction coils, and therefore being distorted by such pushing force or electromagnetic force.

The counter-winding also provides magnetic neutralization, which resists material from ionization. This results in less rusting of the material and better durability of the part.

Also, the apparatus preferably has individual quenching sections (with different pressures and flows) to maximize physical properties of the part. Quenching with liquid is done longitudinally, but also perpendicularly to minimize distortion of the part. Partitioning in each quench plane (up, down, right, and left) is controlled in the quenching process, which can avoid part distortion, such as camber, twisting and bowing. This solves some of the distortion concerns with parts produced in continuous production.

### BRIEF DESCRIPTION OF THE DRAWINGS

The above-mentioned and other features of this disclosure and the manner of obtaining them will become more apparent, and the disclosure itself will be best understood by reference to the following descriptions of systems and processes taken in conjunction with the accompanying figures, which are given as non-limiting examples only, in which:

FIG. 1 shows a prior art schematic of a heat-treating production line from U.S. Pat. No. 4,394,194;

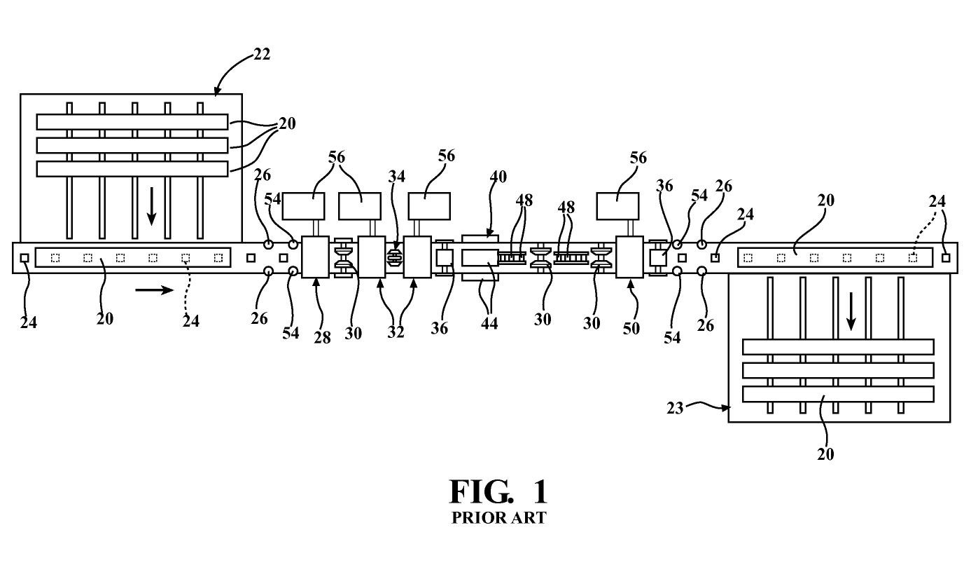

FIG. 2 shows a view of a portion of an induction heat-treating apparatus having a heating coil assembly with sections wound in opposite directions; and

FIG. 3 shows a view of a quenching section.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the figures show, and herein described in detail, embodiments with the understanding that the present descriptions are to be considered exemplifications of the principles of the disclosure and are not intended to be exhaustive or to limit the disclosure to the details of construction and the arrangements of components set forth in the following description or shown in the figures.

The disclosed process and apparatus are well suited for side rails of a vehicle, and particularly C-channels having a C-shaped cross-section. Both can heat-treat the part 58, but also minimize distortion of the part 58.

An apparatus 60 for induction heat treating and quenching a metallic part 58 may have rolls to convey, guide and restrain the part 58 along a treatment line. An entry table can load the part 58 onto the treatment line with initial conveyor rolls and subsequent guide rolls and pinch and restraint rolls as needed. The rolls may be computer controlled.

The line includes a heating station 62, a quenching station 64 and a second heating station 66 before or preferably after the quenching station 64, wherein the second heating station 66 after the quenching station 64 tempers the part 58. However, the second heating station 66 need not be located after the quenching station 64. With an improved heating coil assembly 68 at the initial heating station 62, preheating may no longer be required.

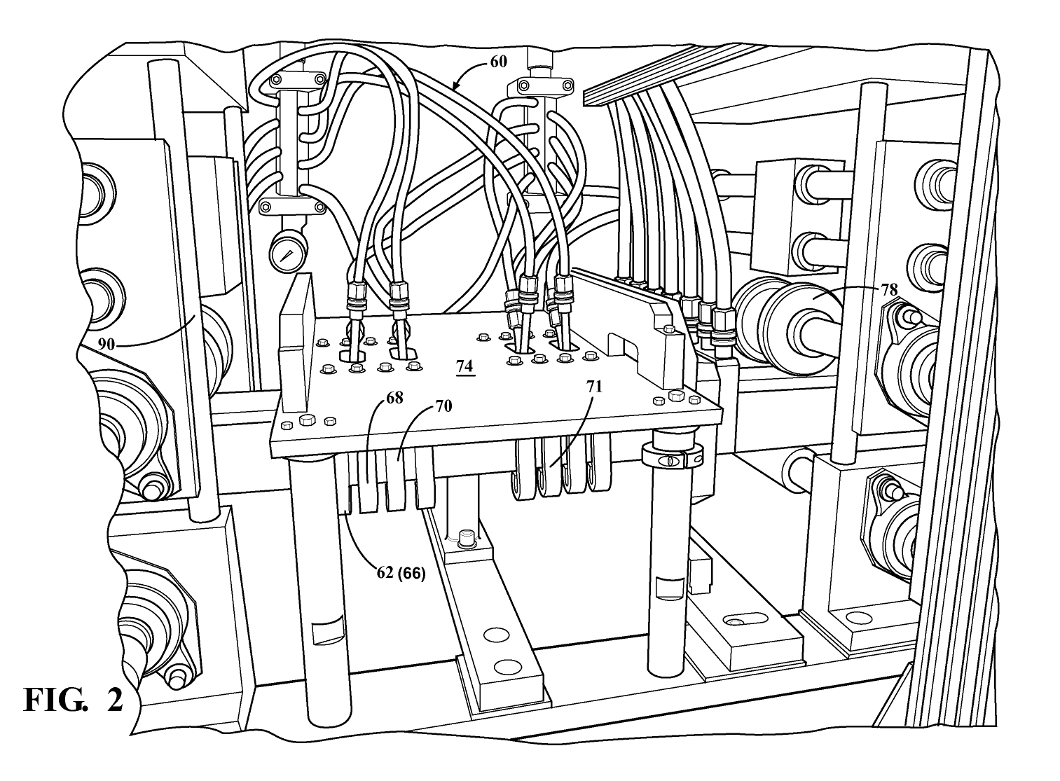

Each heating station may include a heating coil assembly 68 with two sections of coils 70 and 71 wound in opposite directions as shown in FIG. 2. The counter-wound coil assembly 68 may have a section of coil 70 and 71 with initiation from one side, and another coil with initiation on the other side of the coil. The induction on one section of coil 70 or 71 is preferably done from one distal end of the coil to the other extreme, and a second section of coil is wound the other way around with induction in an opposite direction wherein the coil assembly 68 provides substantial magnetic neutralization and minimal pushing force.

The apparatus 60 includes a space 74 between and separating the heating coils to allow the temperature of the part 58 to be leveled. The coil sections 70 and 71 can use the same frequency and power source for the heating coil assembly 68, wherein the power (kW) and frequency (kHz) are controlled by a computer.

The coil size for the initial heating station 62 may be in a preferred range relative to the part 58. Its shape may be substantially circular or in a specific shape corresponding to the part 58.

The apparatus 60 preferably has a means 78 for controlling speed and deceleration/acceleration of the part 58 through the apparatus 60. A computer may control the rolls so that the part 58 can vary speed, acceleration and deceleration through entrance into the apparatus 60, each station 62, 64 and 66, and the exit of the apparatus 60. The exit speed of the part 58 from the apparatus 60 may differ from an entrance speed of the part 58 into the apparatus 60, although this speed difference is not required. Controlling an exit speed of the part 58 from the apparatus 60 and an entrance speed of the part 58 into the apparatus 60 may help control the quality of the part 58.

The preferred speed of the part 58 through the initial heating station 62 may be slower than 100 inches per minute. The speed may be varied through the heating station 62, the quenching station 64 and the second heating station 66.

The relationship between the speed and coil size of the initial heating station 62 may be varied, and the distance and separation between heating stations 62 and 66 can level temperature to ensure homogeneous heating of the part 58 and its particular shape. This may avoid the need for a separate preheating coil. Further, the first heating station 62 may heat the part at a faster rate since the objective is to heat the part as much as possible to the desired temperature and less temperature control is required. The second heating station 66 preferably provides a more controlled increase in temperature to avoid distortion of the part 58. This is particularly true where the part 58 is a C-channel which can have side edges and a central web which can heat differently from each other and be more prone to distortion. Preferably, the speed and coil size of each heating station 62 or 66 heat the whole part 58 at the same time so as to heat the part 58 most uniformly or homogeneously, particularly when tempering the part 58 in the second heating station 66.

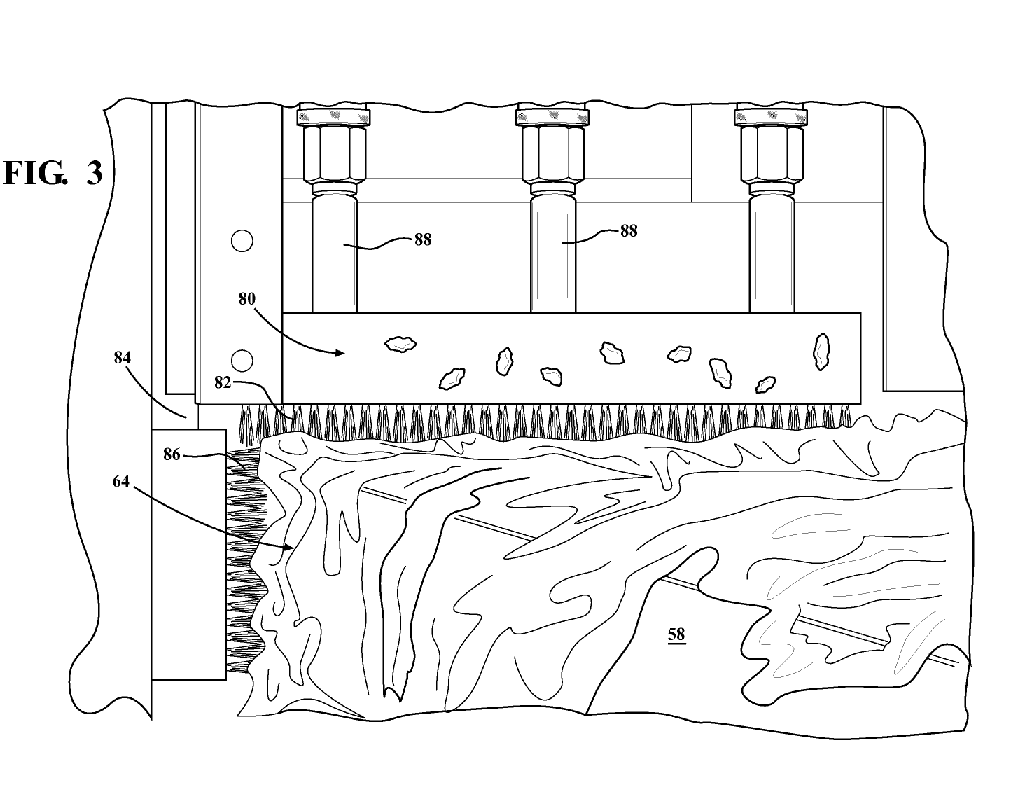

FIG. 3 shows a quenching station 64 with a horizontal block 80 having sprayers 82 and a vertical block 84 having sprayers 86. The quenching is preferably done with liquid sprayed both longitudinally and perpendicularly. The sprayers 82 and 86 may be angled, such as toward the direction of movement of the part 58, to preferably direct the quenching liquid in a desired direction and to avoid the liquid from spraying into the wrong area of the apparatus 60. As an example, water may be supplied from tubes 88 into block 80 to spray liquid via numerous closely aligned sprayers 82.

The quenching station 64 preferably has individual quenching sections (such as 80 and 84) having different pressures and flows of liquid. Other arrangements of quenching stations are contemplated. Each quenching section may use a liquid, such as water, for quenching the part 58. A computer may control the individual quenching sections with different pressures and flows and the direction of flow of the liquid.

The improved and variable control of the quenching station 64 uses less liquid than the prior art. A flow of 50-150 gallons per minute for quenching is less than an estimated flow of 500-1,000 gallons per minute for prior art quenching.

The apparatus 60 preferably includes a means 90 for controlling proximity of the part 58 to the heating coil assembly 68. A computer may control the rolls so that the part 58 is passed by each heating coil assembly 68 at a desired distance, although computer control may not be required. The part proximity may be set in a preferred range.

A process for induction heat treating and quenching a metallic part 58 using an apparatus 60 includes induction heating the part 58 in a counter-wound coil assembly 68; quenching the part 58 with a liquid while under restraint, preferably in individual quenching sections 80 and 84 using different pressures and flows; restraining the part 58 in a series of restraining rolls during quenching; and induction heating the part 58 again after quenching.

The process preferably includes controlling speed of the part 58 through the apparatus 60 including entry, each station, and exit. A computer can control the speed and deceleration/acceleration of the part 58 through the apparatus 60 although is not required for such control. Similarly, the proximity of the part 58 to the heating coil assembly 68 can be set or controlled by a computer.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

What is claimed is:

1. A process for induction heat treating including quenching a metallic part of a vehicle structural frame in an apparatus, the process comprising:
controlling speed of the part through the apparatus;
induction heating the part in a counter-wound coil assembly;
quenching the part with a liquid while under restraint, including the step of restraining the part in a series of restraining rolls during quenching; and
induction heating the part again after quenching.

2. The process of claim 1 wherein an exit speed of the part from the apparatus differs from an entrance speed of the part into the apparatus.

3. The process of claim 1 wherein the quenching occurs in individual quenching sections with different pressures and flows.

4. The process of claim 1 wherein the quenching is done longitudinally and perpendicularly.

5. The process of claim 1 wherein proximity of the part to the coil assembly is controlled by a computer.

6. The process of claim 1 in which induction heating after quenching is done in a counter-wound coil assembly with heating coil sections wound in opposite directions to temper the part.

7. The process of claim 1 including a step of controlling speed and acceleration of the part through the apparatus with rolls.

8. The process of claim 1 further comprising a step of controlling proximity of the part to the coil assembly.

9. The process of claim 1 wherein quenching the part with the liquid is in individual quenching sections with different pressures and flows of the liquid controlled by a computer.

10. An apparatus suitable for induction heat treating and quenching a metallic part with rolls to convey, guide and restrain the part, comprising the improvement wherein said apparatus includes a heating coil assembly with sections of coils wound in opposite directions.

11. The apparatus of claim 10 further comprising a means for controlling speed and acceleration of the part through the apparatus.

12. The apparatus of claim 10 further comprising a means for controlling proximity of the part to the heating coil assembly.

13. The apparatus of claim 10 wherein induction on one section of coil is done from one distal end of the coil to the other extreme, and a second section of coil is wound the other way around with induction in an opposite direction wherein the coil assembly provides substantial magnetic neutralization.

14. The apparatus of claim 10 further comprising a quenching station with individual quenching sections having different pressures and flows of a liquid.

15. The apparatus of claim 10 wherein the counter-wound coil assembly has coils that use the same frequency and power source.

16. An apparatus suitable for induction heat treating including quenching of a metallic part with rolls to convey, guide and restrain the part, the apparatus comprising:
a first heating coil assembly with two sections of coils wound in opposite directions;
a single power source for both sections of coils;
a means for controlling varying speed of the part through the apparatus; and
a quenching station with individual quenching sections having different pressures and flows of a liquid.

17. The apparatus of claim 16 further comprising a means for controlling proximity of the part to the heating coil assembly.

18. The apparatus of claim 16 further comprising a second heating coil assembly downstream of said quenching station for tempering the part.

19. The apparatus of claim 18, wherein said second heating coil assembly includes two sections of coils wound in opposite directions;
